(19) United States
(12) Patent Application Publication
(10) Pub. No.: US 2009/0035687 A1
(43) Pub. Date: Feb. 5, 2009

(54) Colored Particles and Manufacturing Method Thereof

(76) Inventors: Satoshi Uchino, Tokyo (JP); Mitsutoshi Nakamura, Tokyo (JP); Tatsuya Nagase, Tokyo (JP); Motoi Nishimura, Tokyo (JP); Aya Shirai, Tokyo (JP)

Correspondence Address: Cameron Kerrigan;Squire, Sanders & Dempsey L.L.P., Suite 300, One Maritime Plaza, San Francisco, CA, 94111, US

(21) Appl. No.: 12/176,227

(22) Filed: Jul. 18, 2008

(30) Foreign Application Priority Data
Aug. 2, 2007 (JP) JP2007-201728

(51) Int. Cl. G03G 9/08

(52) U.S. Cl. 430/110.2; 430/137.1

(57) ABSTRACT

Colored particles and their manufacturing method are disclosed. Each of the colored particles composed of a core shell structure comprising a core particle and a colored shell layer formed on a surface of the core particle; and the core particle is composed of a hydrophobic resin; the colored shell layer comprises an active agent structure resin having a hydrophobic part and a hydrophilic part, and a colorant particle; a volume based median particle diameter of the colored particles is 2 to 100 μm; and
a volume based CV value of the colored particles is 1.0 to 15.0%.

This application is based on Japanese Patent Application No. 2007-201728 filed on Aug. 2, 2007, the entire content of which is hereby incorporated by reference.

### TECHNICAL FIELD

The present invention relates to colored particles which are applied to toners for electrophotography, displaying particles for powder display panel display and spacer particles for liquid crystal display and a manufacturing method thereof.

### TECHNICAL BACKGROUND

Hitherto, colored particles containing a polymer and a colorant to be applied to toners for electrophotography and displaying particles for powder display panel display particles are required to have high strength such as that neither deformation nor crushing occurs even when the particles are used for prolonged period. As the method for manufacturing the colored particle composed of polymer, there is a method of dying colorless or white polymer particle by a dye. However, the colored particles obtained such the method causes problems that the particles are dyed only on their surface, colorant is easily dissolved out and the particles having pale color and low coloring ability can be only obtained. Besides, a method of covering the surface of the polymer particle by a pigment is applied. However, it is problem that the pigment is only attached onto the particle surface in the particles prepared by such the method and the pigment is easily released from the particle. In another method, the polymer and the colorant are kneaded, granulated and classified. By such the method, for example, the colorant, binder resin and various additives according to the use are melted and kneaded by a kneader and roughly crushed after cooling and then further finely crushed. However, the colored particles obtained by such the crushing method are broad in the particle size distribution so that classifying according to the particle diameter is necessary. Moreover, the shape of the particles is irregular; therefore, a sphering treatment is necessary some times so that a problem that many processes are necessary is caused Moreover, it is very difficult to uniformly disperse the colorant in the binder resin so that a problem that non-uniformity is caused in the optical and electric properties of the colored particles.

Furthermore, a method for manufacturing the colored particles is disclosed in Patent Publication 1 in which the particles are formed by suspension polymerization or emulsion polymerization of a monomer containing the colorant.

However, the content of colorant has to be very high for obtaining the colored particle having dense color and high coloring ability. Therefore, the content of the binder resin is inevitably decreased so that the particles are made fragile. The particles prepared by such the method are insufficient in the shape uniformity and sharpness of the particle size distribution; therefore, a classification process according to the shape and size of the particles is made necessary.

For solving the above problems, a method is proposed in which a monomer and colorant absorbed by seed particles are polymerized to obtain colored particles having narrow size distribution; cf. Patent Publication 2, for example.

However, there is limit on the amount of the colorant capable of being contained in the particles and sufficient coloring ability cannot be obtained.

On the other hand, a method is proposed in which core particles having sharp size distribution, surfactant-structure particles having a relatively smaller particle size compared with the core particles and colored particles having a relatively smaller particle size compared with the core particles are fused by applying compressing force and shearing force; cf. Patent Publication 3, for example.

However, in such the method, the surfactant-structural particles are not sufficiently fused with the core particle by the compressing force and the shearing force within the range for not destroying the core particle so that the strength of the obtained particles is insufficient and the surface of the particle is not always smoothed. As a result of that, a problem that non-uniformity is caused in the optical property and the electric property of the particles is caused.

Patent Publication 1: JP A 2004-287061

Patent Publication 2: JP A 2001-89510

Patent Publication 3: JP A H06-126146

### DISCLOSURE OF THE INVENTION

The invention is attained on the above background and an object of that is to provide a colored particle having sufficient particle strength, coloring ability and sharp size distribution and to provide a manufacturing method thereof.

It is found by the inventors that a colored layer can be formed on core particles having sharp particle sized distribution by coagulating and thermally fusing hydrophobic resin core particles having sharp particle distribution with active agent structure resin particles composed of an active agent structure resin having a hydrophobic moiety and a hydrophilic moiety and fine particles of colorant in an aqueous medium, though the particle size distribution of the final colored particles is sharp. Thus the invention can be attained.

The colored particle of the invention is a colored particle having a core-shell structure composed of a core particle and a colored shell layer formed on the surface of the core particle. The core particle contains a hydrophobic resin and the colored layer contains an active agent structure resin having a hydrophobic moiety and a hydrophilic moiety and colorant fine particles, and the mass of the colored particles has a volume based median diameter of from 2 to 100 μm and a volume based CV value of from 1.0 to 15.0.

The manufacturing method of colored particles of the invention is a method for manufacturing the above colored particles. The method comprises the step of coagulating the core particles A, the active agent structure resin particles B and the colorant fine particles C in an aqueous medium for forming the colored shell.

In detail, the method comprises the step of coagulating the core particles A, the active agent structure resin particles B composed of the active agent structure resin formed by polymerization of a monomer having a hydrophilic group and the colorant fine particles C composed of a colorant in an aqueous medium for associating the active agent structure resin particles B and the colorant fine particles C onto the surface of the core particles A and then the particles A, B and C are fused to form the colored layer composed of the active agent structure resin layer containing the colorant.

In the colored particle manufacturing method of the invention, the particle diameter R1 of the core particle A and the particle diameter R2 of the active agent structure resin particle B preferably satisfy the relation of 0.005<R2/R1<0.250. The diameters R1 and R2 are each the volume based median diameter.

In the colored particle of the invention, the active agent structure resin is a resin having a surfactant-structural. The active agent structure resin has the hydrophobic moiety and the hydrophilic moiety for forming the surfactant-structure. The active agent structure resin preferably has a structure in which the hydrophilic group is linked with the hydrophobic structure. The active agent structure resin is preferably formed by an active agent structure resin which is obtained by polymerizing a hydrophobic-hydrophilic monomer having a hydrophobic group containing a polymerizable unit and a hydrophilic group. A vinyl monomer is preferred as the amphoteric monomer. Namely a vinyl monomer is preferable in which the vinyl group of the vinyl monomer functions as the hydrophobic group and the hydrophilic group is linked with the vinyl group.

The hydrophobic group in the invention is an organic group having an organicity of not less than 60 calculated according to H. Inoue, “Separation Method of Organic Compound”, 1990, Shoka-bou. The hydrophobic group is a group having an inorganicity of not less than 70. The hydrophilic group constituting the later-mentioned metal salt has an inorganicity of not less than 400.

In the colored particle manufacturing method of the invention, the hydrophilic group in the active agent structure resin composing the active agent structure resin particle is preferably an —SO₃⁻M⁺ group, a —COO⁻M⁺ group, a —PO₄⁻M⁺ group, an —SO₃⁻M⁺ group, an —N⁺(CH₃)₂.—COO group, a —COOH group (in the above, M is an metal atom or an ammonium group) or a group represented by the following Formula 1 or 2.

—N⁺(CH₃)₃X Formula 1:

—O(CH₂CH₂O)ₘH Formula 2:

In the above Formula 1, X is a halogen atom. In the above Formula 2, m is an integer of 1 or more.

### BRIEF DESCRIPTION OF THE DRAWING

FIG. 1 schematically shows the manufacturing process of the colored particle, and (a) shows the coagulated state of the core particle, surfactant-structural particles and the colorant fine particles and (b) shows a cross section of the colored particle obtained after the fusion.

The colored particles of the invention have sufficient strength, coloring ability and sharp particle size distribution. Moreover, the content of volatile component such as monomer component is low.

According to the colored particle manufacturing method of the invention, the core particle A is composed of the hydrophobic resin and the active agent structure resin particle B is composed of the active agent structure resin having the hydrophobic group and the hydrophilic group. Consequently, the active agent structure resin particles B and the colorant fine particles C can be attached onto the surface of the core particle by salting out by the presence of a salt such as sodium chloride and the active agent structure resin particles B and the colorant fine particles C can be associated with the core particle A by the thermal fusion. The colored shell including the colorant can be formed on the core particle A by such the process. As a result of that, the colored particle having sufficient particle strength, coloring ability, sharp particle size distribution and low content of the volatile components can be obtained.

### PREFERRED EMBODIMENT OF THE INVENTION

The invention is concretely described below.

<Colored Particle>

The colored particle of the invention has the core-shell structure composed of the core particle A which includes almost no colorant and the colored shell which is composed by the active agent structure resin having the hydrophobic moiety and the hydrophilic moiety and containing the colorant.

It is preferable that the colored shell layer completely covers the core particle.

The particle size of the colored particle of the invention is within the range of from 2 to 100 μm in volume based median diameter. Preferable range is from 3 to 30 μm for example though the diameter is differed according to the use. The particle size can be controlled by controlling the concentration of the coagulating agent or the coagulation time in the later-mentioned manufacturing process, the composition of the hydrophobic resin constituting the core particle A or the composition of the active agent structure resin of the colored shell layer.

The volume based median diameter of the colored particle is measured and calculated by using Coulter Multisizer TA-III connected with a dater processing computer system, each manufactured Beckman Coulter Inc. In concrete, 0.02 g of colored particles to be measured are wetted by 20 ml of a surfactant solution, for example a surfactant solution for dispersing the measurement sample prepared by diluting a neutral detergent by 10 times, and dispersed by applying ultrasonic wave for 1 minute to prepare a sample dispersion. The sample dispersion is poured by a pipette into a beaker containing ISOTON II, manufactured by Beckman Coulter Inc, set on the sample stand until the density indicated by the measuring apparatus is reached at 8%. Measuring result having high repeatability can be obtained by adjusting the density by such the value at this time. The counting number of particle is set at 25,000 on the measuring apparatus and the aperture diameter is each set at 100 μm and 50 μm when the volume based median diameter of the particles to be measured is not less than 10 μm and less than 10 μm, respectively. The frequency of the size distribution of the measured results is calculated and the median diameter is determined at the diameter of 50% from the larger side of the integral ratio of the volume.

The colored particles of the invention have a variation coefficient (CV value) indicating the particle size distribution of from 1.0 to 15%, and preferably from 1 to 10%. The coloring ability of the colored particles can be given and the pressured applied to the colored particle can be made uniform by that the particle size distribution is sharp as above. Consequently, an advantage on the particle strength such as that the deformation and crushing of the colored particles are difficultly caused can be obtained.

The CV value is expressed by the following expression X.

CV value(%)={Standard deviation}/Volume based median diameter)}×100 Expression X:

<Manufacturing Method of Colored Particle>

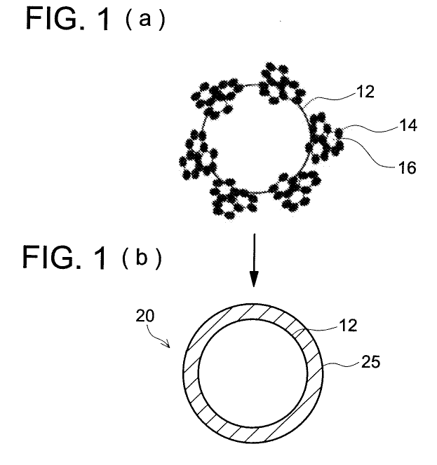

The colored particles are manufactured by coagulating the core particles 12, surfactant-structure resin particles 16 and the colorant fine particles C 14 composed of the colorant in the aqueous medium so as to attach the active agent structure resin particles 16 and the colorant fine particles C 14 onto the surface of the core particle 12 (cf. FIG. 1a) and fusing the active agent structure resin particle to form the colored shell layer 25 on the surface of the core particle 12. Thus the colored particle 20 is prepared (cf. FIG. 1b).

A concrete example of the manufacturing processes of the colored particles of the invention in which the active agent structure resin particles are used and the colorant is introduced into the colored shell layer are shown below.

(1) A process for manufacturing the core particles composed of the hydrophobic resin.

(2) A process for manufacturing the active agent structure resin particles composed of the active agent structure resin prepared by polymerization of the polymerizable monomer having the hydrophilic group.

(3) A process for preparing the dispersion of the colorant particles C by dispersing the colorant into fine particles in the aqueous medium.

(4) A coagulating process for preparing coagulated particles by mixing the core particles, active agent structure resin particles and the colorant fine particles C in the aqueous medium for attaching the surfactant-structural-particles and the colorant fine particles onto the surface of the core particle.

(5) A process for forming the colored particles having the colored shell layer by thermally fusing the coagulated particles prepared by the process (4).

The aqueous medium is a medium composed of from 50 to 100% by weight of water and from 0 to 50% by weight of a water miscible organic solvent. As the water miscible organic solvent, methanol, ethanol, isopropanol, butanol, acetone, methyl ethyl ketone and tetrahydrofuran can be exemplified and an alcoholic organic solvent which cannot dissolve the resin to be obtained is preferable.

### (1) Core Particle Preparation Process

The core particle to be used in the colored particle manufacturing method of the invention is particle to be made as the core particle in the colored particle and is composed of the hydrophobic resin.

Such the core particles can be prepared by a polymerization method such as emulsion polymerization method, suspension polymerization method or dispersion polymerization method.

Here, the hydrophobic rein is a resin formed by polymerizing a monomer composition containing a hydrophobic monomer having solubility in deionized water of less than 0.1% by weight as a main component. The main component is a component occupying not less than 51% of the entire components of the monomer composition. The solubility of the hydrophobic monomer in deionized water is concretely measured by that the hydrophobic monomer is added to 100 ml of deionized water at 25° C. and stirred and then standing for 24 hours and filtered, and the weight the hydrophobic monomer contained in the solution is measured after distilling out the deionized water.

Concrete example of the hydrophobic monomer for forming the hydrophobic resin includes styrene type monomers such as styrene, vinyltoluene, 2-methylstyrene, t-butylstyrene and chlorostyrene; acrylic esters such as methyl acrylate ethyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, decyl acrylate and dodecyl acrylate; and methacrylic esters such as methyl methacrylate, propyl methacrylate, n-butyl methacrylate, isobutyl methacrylate, n-amyl methacrylate, n-hexyl methacrylate, 2-ethylhexyl methacrylate, n-octyl methacrylate, decyl methacrylate and dodecyl methacrylate.

The above hydrophobic monomers may be used singly or in combination of two or more kinds of them. When two or more kinds of the hydrophobic monomers are used in combination, the total of the monomers has to occupy not less than 51% by weight of the entire components of the monomer composition to be prepared.

As the polymerization initiator to be used for preparing the core particles by the suspension polymerization, suitable oil-soluble radical polymerization initiator can be cited. Examples of the oil-soluble polymerization initiator include azo or diazo type polymerization initiators such as 2,2′-azobis(2,4-dimethylvaleronitrile), 2,2′-azobis-isobutyronitrile, 1,1′-azobis(dicyclohexane-1-carbonitrile), 2,2′-azobis-4-methoxy-2,4-dimethyl-valeronitrile and azobisisobutyronitrile; peroxide type polymerization initiators such as benzoyl peroxide, methyl ethyl ketone peroxide, diisopropyl peroxycarbonate, cumene hydroperoxide, t-butyl hydroperoxide, di-t-butyl peroxide, dicumyl peroxide, 2,4-dichlorobenzoyl peroxide, lauroyl peroxide, 2,2-bis-(4,4-t-butylperoxycyclohexyl)propane and tris-(t-butylperoxy)triazine; and polymer initiators each having a peroxide at the side chain thereof.

As the polymerization initiator to be used for preparing the core particles by the emulsion polymerization, water-soluble radical polymerization initiators are suitably usable. Examples of such the water-soluble radical polymerization initiator include persulfates such as potassium persulfate and ammonium persulfate, azobisaminodipropane acetic acid salts, azobiscyanovaleric acid and its salts and hydrogen peroxide.

When a surfactant is used in the process such as that for the core particle preparation, various surfactants such as an ionic surfactant such as an anionic surfactant, a cationic surfactant and an amphoteric and a nonionic surfactant can be used.

As examples of the anionic surfactant, higher fatty acid salts such as sodium oleate; alkylarylsulfonates such as sodium dodecylbenzenesulfonate; alkylsulfate ester salts such as sodium laurylsulfate; polyoxyethylene alkyl ether sulfonates such as sodium polyethoxyethylene laurylether sulfonate; polyoxyethylene alkylaryl ether sulfonates such as sodium polyoxyethylene nonylphenyl ether sulfate; alkylsulfosuccinate salts such as sodium monooctylsulfosuccinate, sodium dioctylsulfosuccinate and sodium polyoxyethylene laurylsulfosuccinates and their derivatives can be cited. The above surfactants may be used singly or in combination of two or more kinds of them.

The core particle may be constituted by two or more layers of hydrophobic resins each different from each other in the composition thereof. In such the case, a method can be applied in which a dispersion of first resin particles is prepared by usual emulsion polymerization treatment (the first step polymerization) and then a polymerization initiator and a hydrophobic monomer are added to the dispersion and the resultant system is subjected to a polymerization treatment (the second step polymerization).

The hydrophobic resin is preferably one having a peak molecular weight measured by GPC of from 5,000 to 1,000,000 and a glass transition temperature Tg of not less than 70° C. though these values may be varied according to the use of the colored particles to be obtained.

The particle diameter R1 of the core particle A prepared by the above process is preferably from 1.5 to 90 μm, and more preferably from 2.4 to 29 μm. The particle diameter R1 can be controlled by controlling the amount of the hydrophobic monomer or the kind of the polymerization initiator.

The volume based median diameter of the core particles A is measured by the method the same as in the measurement of the above colored particles except that the sample is replaced by the core particles A.

When the volume based median diameter of the core particles A is within the above range, the colored particles having sharp particle size distribution and sufficient strength and coloring ability can be obtained.

The core particles A prepared by the above process is preferably has a variation coefficient (CV value) indicating the particle size distribution of not more than 15%, and more preferably not more than 10%. When the CV value is within the above range, the particle size distribution of the colored particles becomes extremely sharp.

### (2) Preparation Process of Active Agent Structure Resin Particles B

The active agent structure resin particles B used in the manufacturing of the colored particles of the invention are used for fixing the colorant fine particles C onto the surface of the core particles. The resin has the hydrophilic moiety and the hydrophobic moiety so as to form the structure of surfactant. In concrete, the resin has a surfactant-structure in which the hydrophilic group is linked with the hydrophobic structural body.

The surfactant-structural rein particles B having such the structure can be manufactured by a polymerization method such as an emulsion polymerization method, a suspension polymerization method and a dispersion polymerization method.

As the hydrophilic group in the active agent structure resin constituting the active agent structure resin particles B, a —SO₃⁻M⁺ group, a —COO⁻M⁺ group, a —PO₄⁻M⁺ group, a —SO₃⁻M⁺ group, a —N⁺(CH₃)₂.COO⁻ group, a —COOH group (in the above, M is an metal atom or an ammonium group) or a group represented by the following Formula 1 or 2 can be cited. Concrete examples of M include Na, NH(CH₂CH₂OH)₃ and N(CH₂CH₂OH)₂.

—N⁺(CH₃)₃X⁻ Formula 1:

—O(CH₂CH₂O)ₘH Formula 2:

In the above Formula 1, X is a halogen tom. In the above Formula 2, m is an integer of 1 or more.

Such the hydrophilic group is introduced in the surfactant-structural particle B by the following method.

(A) An amphoteric polymerizable monomer having both of a polymerizable group including a polymerizable unit such as a vinyl structure and the hydrophilic group is used as the monomer to form the active agent structure resin constituting the active agent structure resin particles B.

(B) Mother resin particles composed of a hydrophobic active agent structure resin formed by polymerization of a hydrophobic monomer is subjected to plasma treatment for making the surface of the mother particles hydrophilic.

As the amphoteric polymerizable monomer to be used in the method (A), sodium 4-vinylbenzenesulfonate, ammonium poyoxyethylene-1-(allyloxymethyl)alkylethersulfate and ammonium polyoxyethylenealkylpropenylphenylether sulfate can be exemplified. These monomers may be used alone or in combination of two or more kinds of them.

In the method (A), the amphoteric monomer is preferably used together with another polymerizable monomer to form a copolymer. As the other polymerizable monomer, those cited as the hydrophobic monomer for constituting the above hydrophobic resin are usable.

The using amount of the amphoteric monomer is from 0.5 to 10 parts by weight of 100 parts by weight of the composition for forming the active agent structure resin particles B.

When the active agent structure resin particles B are prepared by the suspension polymerization, the polymerization initiators cited as those to be used for preparing the core particles A by the suspension polymerization method are usable.

When the active agent structure resin particles B are prepared by the emulsion polymerization, the polymerization initiators cited as those to be used for preparing the core particles A by the emulsion polymerization method are usable.

Furthermore, when a surfactant is used in this process for preparing the surfactant-structural particles B, those cited as the surfactants to be used for preparing the core particles A are usable.

The active agent structure resin is preferably one having a peak molecular weight measured by GPC of from 5,000 to 70,000 and a glass transition temperature Tg of from 40° C. to 90° C. though these values may be varied according to the use of the colored particles to be obtained.

The glass transition temperature Tg of the active agent structure resin or the hydrophobic resin is measured by a differential scanning calorimeter DSC-7 and a thermal analyzer controller TAC7/DX, each manufactured by PerkinElmer Inc. In concrete, 4.50 mg of a measuring sample of the active agent structure resin of the hydrophobic resin is enclosed in an aluminum pan Kit No. 0219-0046 and the pan is set on the sample holder of DSC-7. An empty aluminum pan is used for the reference measurement. Heat-cool-heat control is performed under conditions of a temperature rising rate of 10° C./minute and a temperature lowering rate of 10° C./minute and data at the secondary heating are measured. The glass transition temperature Tg is determined by the cross point of the prolongation of the base line before the standing up of the first endothermic peak and the normal line having the maximum inclination angle between the standing up point of the first endothermic peak and the top of the endothermic peak. At the first temperature rising process, the temperature is held at 200° C. for 5 minutes.

The measurement of the molecular weight of the active agent structure resin or the hydrophobic resin by GPC is carried out as follows. A GPC apparatus HLC-8220 and columns of triplet of TSK guard column+TSK gel Super HZM-M, each manufactured by Tosoh Corp., are used for the measurement. Tetrahydrofuran (THF) is run out as the carrier solvent at a flowing rate of 0.2 ml/minute through the columns while keeping the temperature at 40° C. Besides the sample (the active agent structure resin or the hydrophobic resin) is dissolved in tetrahydrofuran at a concentration of 1 mg/ml by ultrasonic wave treatment for 5 minutes at room temperature and then treated by a membrane filter having a pore size of 0.2 μm to prepare a sample solution. Ten microliter of the sample solution is injected into the apparatus together with the above carrier solvent and detected by a refractivity detector (RI detector) and the molecular weight distribution of the measured sample is calculated by using a calibration line prepared by using monodispersed polyethylene standard particles. As the standard polystyrene samples for preparing the calibration line, samples, manufactured by Pressure Chemicals Co., each having a molecular weight of 6×10², 2.1×10³, 4×10³, 1.75×10⁴, 5.1×10⁴, 1.1×10⁵, 3.9×10⁵, 8.6×10⁵, 2×10⁶ and 4.48×10⁶ are used. At least about 10 kinds of the standard sample are measured for preparing the calibration line. The refractive index detector is used as the detector.

The particle diameter R2 of the active agent structure resin particles B and the particle diameter R1 of the core particles are preferably satisfy the relation of 0.005<R2/R1<0.250, and more preferably 0.010<R2/R1<0.200.

The particle diameter R2 of the active agent structure resin particles B can be controlled by controlling the polymerization time.

When the ratio of the particle diameter R2 of the active agent structure resin particles B to the particle diameter R1 of the core particles A is within the above range, the colored particles having the sharp particle size distribution, sufficient particle strength and coloring ability can be obtained.

The particle diameter R2 of the active agent structure resin particles B is represented by the volume based median diameter and the volume based median diameter is determined by the following method using the active agent structure resin particles B as the measuring sample.

The active agent structure resin particles B preferably have a variation coefficient (volume based CV value) of not more than 15% and more preferably not more than 10%. When the volume based CV value is within the above range, the shell layer containing the colorant in the highly dispersed state can be formed.

The volume based median diameter and the volume based CV value of the active agent structure resin particles B is measured by a dynamic light scattering nanotrack particle size measuring apparatus MICROTRACK UPA 150, manufactured by Honeywell Inc., under the following conditions.

(Measuring Conditions)

Refractive index of sample: 1.59

Specific gravity of Sample: 1.05 in terms of spherical particle

Refractive index of solvent: 1.33

Viscosity of solvent: 0.797 (30°), 1.002 (20°)

Zero point adjusting: Zero point is adjusted by charging deionized water into the measuring cell.

### (3) Colorant Fine Particles C Preparation Process

Various kinds and colored organic or inorganic pigments or dyes can be used as the colorant constituting the colorant particles of the invention.

Concrete examples of the black colorant include a carbon black such as furnace black, channel black, acetylene black, thermal black and lamp black and a magnetic powder such as magnetite and ferrite. As examples of white colorant, titanium oxide, aluminum oxide and silica are cited.

Such the colorant is added to the reaction system in a state of dispersion of colorant fine particles C dispersed in an aqueous medium by a dispersing machine.

In the manufacturing method of the colored particles, the particle diameter of the colorant fine particles C to be coagulated in the coagulation process is preferably from 20 to 200 nm, and more preferably from 40 to 150 nm, in the volume based median diameter. The volume based median diameter of the colorant fine particles C is measured by the same method as in the measurement of that of the active agent structure resin particles.

When the particle diameter of the colorant fine particles C is within the above range in mass average diameter, fusion on the core particles A can be performed rapidly and strongly. Moreover, it is advantageous for the industrialization since any released colorant particle is not formed so that the yield of the colored particles is made higher and the treatment of drained water can be easily carried out.

For controlling the particle diameter of the colorant fine particles C so that the diameter is within the above range, for example, control of the stress of the shearing stirring for preparing the dispersion of the colorant fine particles C and addition of suitable kind and amount of surfactant can be applied.

As the dispersing machine for dispersing the colorant fine particles C, a mechanical dispersing machine CLEARMIX manufactured by M technique can be cited.

### (4) Coagulation Process

In the coagulation process, the core particles A or their dispersion, the surfactant-structural rein particles B or their dispersion, the colorant fine particle dispersion C and another dispersion of colored particle constituting material according to necessity are mixed and gradually coagulated while suitably taking balance between the repulsion force of the fine particle surface controlled by pH control and the coagulating force controlled by addition of a coagulating agent composed of an electrolyte so as to obtain coagulated particles by attaching the active agent structure resin particles B and the colorant fine particles C onto the surface of the core particle A while controlling the size and distribution of the particles.

As the coagulating agent to be used in this process, alkali metal salts and alkali-earth metal salts are usable. Lithium, potassium and sodium can be cited as the alkali metal and magnesium, calcium, strontium and barium can be cited as the alkali-earth metal of the coagulating agent. Among them, potassium, sodium, magnesium, calcium and barium are preferable. As the counter ion (an anion for forming the salt) of the alkali metal or the alkali-earth metal, a chloride ion, bromide ion, iodide ion, carbonate ion and sulfate ion are applicable.

Sodium chloride may be added in this process for example. The binder resin particles and the colorant fine particles C can be attached onto the surface of the core particle A by salting out by the presence of the salt such as sodium chloride and thermally fused so that the colored shell layer containing the colorant can be formed.

The adding ratio of the core particles, an active agent structure resin particles B and the colorant fine particles C to the reaction system mA:(mB+mC) is preferably from 60:40 to 95:5, mA:mB is preferably from 50:50 to 90:10 and mB:mC is preferably from 100:2 to 100:20 and more preferably from 100:4 to 100:12; in the above, mA, mB and mC are each the weight of the core particles A, surfactant-structural particles B and colorant fine particles C, respectively.

When the adding amount ratios of each of the constituting components are within the above ranges, both of the strength and coloring ability of the colored particles can be sufficiently obtained.

Coagulation process (4) is performed as follows, for example.

Firstly, the core particles A (or their dispersion), the active agent structure resin particles B (or their dispersion) and the colorant fine particles C dispersion are put into the aqueous medium and mixed. Thus homo-coagulation of the active agent structure resin particles B and hetero-coagulation of the active agent structure resin particles B and the colorant fine particles C are simultaneously caused and the active agent structure resin particles B and the colorant fine particles C are attached onto the surface of each of the core particles A by the hydrophobic interaction of the hydrophobicity of the hydrophobic structure of the active agent structure resin constituting the active agent structure resin particles B and the hydrophobicity of the hydrophobic resin constituting the core particles A. Thus the coagulated particles are obtained.

The coagulation process can be also carried out as follows.

The active agent structure resin particles B (or their dispersion) and the colorant fine particle dispersion are put into the aqueous medium for simultaneously causing the homo-coagulation of the active agent structure resin particles B and hetero-coagulation of the active agent structure resin particles B and the colorant fine particles C to form coagulated particles for forming the shell layer. And then, the core particles A (or their dispersion) are poured to the aqueous medium for attaching the shell layer forming coagulated particles into the surface of each of the core particles A by the interaction of the hydrophobicity of the hydrophobic structure of the active agent structure resin constituting the active agent structure resin particles B and the hydrophobicity of the hydrophobic resin constituting the core particles A. Thus the coagulated particles can be obtained.

### (5) Colored Shell Forming Process

In this process, the coagulated particles obtained by the coagulation process (4) are thermally treated for fusing of each fine particles and controlling the shape thereof by thermally fusing the active agent structure resin particles to form the colored particles having the colored shell layer of the surfactant-structural layer containing the colorant.

The thermally treatment temperature has to be higher than the glass transition temperature of the active agent structure resin constituting the active agent structure resin particle B and lower than that of the hydrophobic resin constituting the core particle A and is carried out at a temperature from 60 to 99° C. for example though the temperature is varied according to the combination of the glass transition temperatures of each of the resins.

The above-mentioned colored particles have satisfactory strength and coloring ability, sharp size distribution and low volatile substance content.

In the above-mentioned manufacturing method of the colored particles, the active agent structure resin particles B and the colorant fine particles C can be attached and thermally fused onto the surface of each of the core particles by the salting out by the presence of the salt such as sodium chloride because the core particles A are composed of the hydrophobic resin and the active agent structure resin particles B are composed of the resin having the surfactant structure. Consequently, the colored particles having satisfactory strength and coloring ability, sharp size distribution and low volatile substance content can be obtained.

### EXAMPLES

Concrete Examples of the invention are described below. Synthesis example 1 of core particle

### (1) First Step of Polymerization: Polymerization of Active Agent Structure Resin

In a 1 L four-mouthed flask on which a thermometer and a nitrogen gas introducing device were attached, 100 parts by weight of styrene (St) and 300 parts by weight of water were charged and mixed by stirring and the temperature of the mixture was raised by 80° C. while stirring in nitrogen gas stream. And then 0.5 parts by weight of potassium per sulfate was added to the above mixture and reaction was performed for 6 hours while keeping the temperature at 80° C. to obtain dispersion A of polymer particles A. According to electron microscopic observation, the polymer particles A were likely like true sphere particles each having almost the same particle size, which have a volume based median diameter of 0.41 μm and a variation coefficient (CV value) of 1.8%. The solid content of the dispersion A was 24.2% by weight.

### (2) Second Step of Polymerization

In a 1 L four-mouthed flask on which a thermometer and a nitrogen gas introducing device were attached, 120.2 parts by weight of styrene and 1.0 part by weight of benzoyl peroxide were charged and dissolved and 300 parts by weight of water, 3.3 parts by weight of NYUCOLE 707SN, manufactured by Nippon Nyukazai Co., Ltd., and 0.1 parts by weight of sodium nitrite were further added to the resultant solution and vigorously stirred for 10 minutes.

Then 34.6 parts by weight of the polymer A of the dispersion A prepared in the first step of the polymerization was added to the above mixture and gently stirred for 30 minutes at 50° C. and made react for 2 hours at 75° C. to obtain dispersion B of polymer particles B. According to electron microscopic observation, the polymer particles B were likely like true sphere particles each having almost the same particle size, which have a volume based median diameter of 1.83 μm and a variation coefficient (CV value) of 4.8%. The solid content of the dispersion B was 33.2% by weight.

### (3) Third Step of Polymerization

In the similar flask, 124.2 parts by weight of styrene and 1.0 part by weight of benzoyl peroxide were charged and dissolved and then 200 parts by weight of water, 3.3 parts by weight of NYUCOLE 707SN, manufactured by Nippon Nyukazai Co., Ltd., and 0.1 parts by weight of sodium nitrite were further added to the resultant solution and vigorously stirred for 10 minutes. Then 15.6 parts by weight of the polymer B of the dispersion B prepared in the second step of the polymerization was added to the above mixture and gently stirred for 30 minutes at 50° C. and made react for 2 hours at 75° C. to obtain dispersion C of core particles C composed of polystyrene. The solid content of the dispersion C was 32.1% by weight.

According to electron microscopic observation, the core particles C were like true sphere particles each having almost the same particle size, which have a volume based median diameter of 4.31 μm and a variation coefficient (CV value) of 5.9%. The peak molecular weight measured by GPC was 30,000 and the glass transition temperature Tg was 98° C. Synthesis example 1 of active agent structure resin particle

In a 1 L four-mouthed flask on which a thermometer and a nitrogen gas introducing device were attached 99 parts by weight of styrene (St), 1 part by weight of sodium 4-vinylbenzene-sulfonate (NaSS) and 400 parts by weight were charged and heated by 80° C. while stirring under the nitrogen stream. Then 0.5 parts by weight of potassium persulfate was added to the resultant mixture and made react for 6 hours while keeping 80° C. to obtain an active agent structure resin particle dispersion D of the polymer particles D. According to electron microscopic observation, the polymer particles D were like true sphere particles each having almost the same particle size, which have a volume based median diameter of 0.12 μm and a variation coefficient (CV value) of 8.2%. The solid content of the surfactant-structural rein particle dispersion D was 20.1% by weight. The peak molecular weight measured by GPC of was 5,000 and the glass transition temperature Tg was 90° C.

### Preparation Example 1 of Colorant Fine Particle Dispersion

Twenty parts by weight of carbon black Regal 330R, manufactured by Cabot Corp., was gradually added to a solution prepared by dissolving 9.2 parts by weight of sodium n-dodecylsulfate in 160 parts by weight of deionized water by stirring and then dispersed by a mechanical dispersing machine CLEARMIX, manufactured by M-technique Co., Ltd., to obtain a colorant fine particle dispersion 1. According to measurement by an electrophoretic scattering photometer ELS-800, manufactured by Otsuka Electronics Co., Ltd., the particle size of the colorant fine particle dispersion 1 was 112 nm in median diameter.

### Example 1

Into a 5 L four-mouthed flask on which a thermal sensor, a cooler, a nitrogen introducing device and a stirrer were attached, 155 parts by weight of the core particle dispersion C, 49.5 parts by weight of the active agent structure resin particle dispersion D, 2,000 parts by weight of deionized water and the colorant fine particle dispersion 1 were charged and the temperature of the mixture was adjusted to 30° C. After that, 49 parts by weight of sodium chloride was added to the mixture and the pH of the resultant mixture was adjusted to 8.0. And then the mixture was stirred for 3 hours for coagulating the core particles, active agent structure resin particles and the colorant fine particles. After that, the liquid was stirred for 3 hours at a liquid temperature of 90° C.±2° C. for fusing the active agent structure resin particles and the colorant fin particles together with each of the core particles to obtain colored particles 1.

The peak molecular weight measured by GPC and the glass transition temperature Tg of the colored particles 1 were each 30,000 and 98° C., respectively.

### Example 2

Colored particles 2 were obtained in the same manner as in colored particles 1 except that the following colorant fine particle dispersion 2 was used in place of the colorant fine particle dispersion 1.

The peak molecular weight measured by GPC and the glass transition temperature Tg of the colored particles 2 were each 30,000 and 98° C., respectively.

### Preparation Example 2 of Colorant Fine Particle Dispersion

Into a solution prepared by dissolving 9.2 parts by weight of sodium n-dodecylsulfate in 160 parts by weight of deionized water, 20 parts by weight of titanium oxide MT-500B, manufactured by Tayca Corp., was gradually added while stirring, and then dispersed by a mechanical disperser CLEARMIX, manufactured by M-technique Co., Ltd., to obtain the colorant fine particle dispersion 2. According to measurement of the particle diameter of the colorant in the colorant fine particle dispersion 2 by the electrophoretic scattering photometer ELS-800, manufactured by Otsuka Electronics Co., Ltd., the volume based median diameter was 85 nm.

### Example 3

Colored particles 3 were obtained in the same manner as in Example 1 except that 49.8 parts by weight of the following core particles E was used in place of 155 parts by weight of the core particle dispersion C and 100 parts by weight of deionized water was used.

The peak molecular weight measured by GPC and the glass transition temperature Tg of the colored particles 3 were each 32,000 and 106° C., respectively.

### Synthesis Example 2 of Core Particle (Suspension Polymerization)

Into a 5 L four-mouthed flask on which a thermal sensor, cooler, nitrogen introducing device and stirrer, an aqueous medium prepared by dissolving 30 parts by weight of magnesium pyrophosphate as a sparingly water soluble inorganic salt and 1.5 parts by weight of sodium laurylsulfate as an anionic surfactant dissolved in 3,000 parts by weight of water was charged. Besides, a monomer solution was prepared by adding 10 parts by weight of divinylbenzene and 5 parts by weight of azobisisobutyronitrile to 990 parts by weight of styrene. Then the resultant monomer solution was added into the aqueous medium and stirred at a circumference speed of the stirring wing of 5.0 m/second while keeping the temperature at 70° C. When the polymerization rate was reached at 20%, 1.5 parts by weight of sodium dodecylbenzenesulfonate was added and the suspension polymerization was further continued for 6 hours. Then the reaction mixture was cooled, filtered and the resultant residue was washed to obtain the core particles E.

According to electron microscopic observation, the core particles E were like true sphere particles each having almost the same particle size, which have a volume based median diameter of 5.44 μm and a variation coefficient (CV value) of 12.1%. The peak molecular weight measured by GPC and the glass transition temperature Tg were each 32,000 and 106° C., respectively.

### Example 4

Into a 5 L four-mouthed flask on which a thermal sensor, cooler, nitrogen introducing device and stirrer, 49.5 parts by weight of the following active agent structure resin particle dispersion F, 2,000 g of deionized water and 11.3 g of the colorant fine particle dispersion 1 were charged and the pH of the mixture was adjusted to 10.0 by adding a 2 mol/L sodium hydroxide solution while stirring. After that, 10 parts by weight of a 50 weight percent aqueous solution of magnesium chloride was added and the temperature of the resultant mixture was raised by 65° C. and the particle growing was continued while the temperature was kept at 65° C. The particle diameter was measured in this situation by a dynamic light scattering nanotrack particle size distribution measuring apparatus MICROTRACK UPA 150, manufactured by Honeywell Inc., and the temperature of the liquid was adjusted to 30° C. at the time when the particle diameter became 0.3 μm and then 155 g of the dispersion C of the core particles C and 49 parts by weight of sodium chloride were added and the pH of the liquid was adjusted to 8.0, and the liquid was stirred for 3 hours. After that, the liquid was further stirred for 3 hours at a temperature of 90°±2° C. for fusing the active agent structure resin particles and the colorant fine particles with each of the core particles to obtain colored particles 4.

The peak molecular weight measured by GPC and the glass transition temperature Tg of the core particles 4 were each 30,000 and 98° C., respectively.

### Synthesis Example 2 of Active Agent Structure Resin Particles: Synthesis of Active Agent Structure Resin

Into a 11 four-mouthed flask on which a thermal sensor and a nitrogen introducing device were attached, 90 parts by weight of styrene (St), 1 part by weight of sodium 4-vinylbenzenesulfonate (NaSS), 9 parts by weight of methacrylic acid (MAA) and 400 parts by weight of water were charged and mixed by stirring and the heated by 80° C. while stirring under nitrogen stream. After that, 0.5 parts by weight of potassium persulfate was added to the above mixture and made react for 6 hours while keeping at 80° C. to obtain an active agent structure resin particle dispersion F of polymer particles F. According to electron microphotographic observation of the polymer particles F, the polymer particles F were like true spherical particles having almost the same particle diameter and the volume based median diameter of the particles was 0.13 μm and the variation coefficient (CV value) was 9.1%. The solid content in the active agent structure resin particle dispersion F was 21.0% by weight. The peak molecular weight measured by GPC measurement and the glass transition temperature Tg of the rein were each 6,000 and 88° C., respectively.

### Example 5

Colored particles 5 were prepared in the same manner as in Example 1 except that 49.8 parts by weight of the following core particles K was added in place of 155 parts by weight of the core particle dispersion C and 2,100 parts by weight of deionized water was used.

The peak molecular weight measured by GPC measurement and the glass transition temperature Tg of the colored particles 5 were each 30,000 and 98° C., respectively.

### Synthesis Example 3 of Core Particles (Dispersion Polymerization)

Into a 1 L four-mouthed flask on which a thermal sensor and a nitrogen introducing device were attached, 6.3 parts by weight of polystyrene and 242 parts by weight of methanol were charged and mixed by stirring and heated by 60° C. under nitrogen stream while stirring. And then 0.4 parts by weight of azobisisobutyronitrile was added and made react for 24 hours while keeping the temperature at 60° C. Then the resin particles were separated by centrifuge and washed twice by methanol replacing and dried to prepare the core particles K.

According to electronmicrophotographic observation of the polymer particles K, the polymer particles F were like like true spherical particles having almost the same particle diameter and the volume based median diameter of the particles was 4.81 μm and the variation coefficient (CV value) was 4.3%. The peak molecular weight measured by GPC measurement and the glass transition temperature Tg of the rein were each 30,000 and 98° C., respectively.

### Comparative Example 1

In 80.0 parts by weight of methyl methacrylate (MMA), 2.0 parts by weight of an oil-soluble dye C.I. Solvent Blue 33 (solubility in MMA: 4.2 parts by weight) and 1.0 part by weight of dimethyl-2,2′-azobis(2-methylpropionate V-601, manufactured by Wako Pure Chemical Industries Ltd., were dissolved and 200 parts by weight of water, 10.0 parts by weight of an emulsifying agent NYUCOL 707SN, manufactured by Nippon Nyukazai Co., Ltd., and 0.05 parts by weight of sodium nitrite as a polymerization preventing prohibiting agent were further added and mixed for 10 minutes by vigorously stirring.

To the resultant mixture, 62.3 parts by weight of the core particles C were added and gently stirred for 30 minutes at 50° C. and then reaction was made for 2 hours at 80° C. and further 2 hours at 90° C. to obtain comparative colored particles 6. The amount of monomers remaining in the particles was 0.73% by weight.

The colored particles 6 have a peak molecular weight of 20,000 and a glass transition temperature Tg of 95° C.

### Comparative Example 2

One hundred parts by weight of the core particles C and 23 parts by weight of finely powdered carbon black Regal 330R, manufactured by Cabot Corp., were mixed for 3 minutes by hybridizer system of O.M. DIZER, manufactured by Nara Machinery Co., Ltd., to form an ordered mixture composed of the core particle C covered with the carbon black fine particles. The ordered mixture was mixed for 3 minutes by a hybridizer of the hybridization system for fixing the carbon black fine particles onto the surface of each of the core particles C to obtain colored particles G.

After that, One hundred parts by weight of the colored particles G and 17 parts by weight of polystyrene fine particles having a volume based median diameter of 0.16 μm was mixed by the O.M. DIZER of hybridization to form an ordered mixture. The ordered mixture was treated for 5 minutes by the hybridizer of hybridization system for fixing the polystyrene fine powder on the surface of each of the colored particles G to form comparative colored particles 7.

The colored particles 7 had a peak molecular weight measured by the GPC method of 20,000 and a glass transition temperature Tg of 95° C.

### Comparative Example 3

Operations the same as those in Example 1 were carried out except that 44.6 parts by weight of the following active agent structure resin particle dispersion H was used in place of 49.5 parts by weight of the active agent structure resin particle dispersion D. According to observations by a laser microscope and a scanning electron microscope, any colored particle could not be obtained.

### Synthesis Example 4 of Active Agent Structure Resin Particles: Emulsion Polymerization

Into a reaction vessel having a stirring device (with three receding wings), a heat-cooling device, a condensation device and monomer charging devices for each monomer, 393 parts by weight of deionized water was charged and heated by 90° C. under nitrogen stream and 1.6 parts by weight of an 8% hydrogen peroxide aqueous solution was added. After that, a mixture of a monomer solution composed of 79 parts by weight of styrene dissolved in 0.4 parts by weight of divinylbenzene and an emulsifying agent aqueous solution prepared by mixing one part by weight of a 15% dodecylbenzenesulfonic acid aqueous solution and 25 parts by weight of deionized water was added spending 5 hours after beginning of the polymerization. Besides an initiator aqueous solution composed of 9 parts by weight of an 8% hydrogen peroxide aqueous solution and 9 parts by weight of an 8% aqueous solution of ascorbic acid was added spending 6 hours after beginning of the polymerization. The reaction system was further maintained for 30 minutes and then cooled to obtain a milky-white polymer dispersion H composed of polymer particles H. The volume based median diameter and variation coefficient (CV value) of the polymer particles H were each 120 nm and 9.9%, respectively. The peak molecular weight measured by GPC and the glass transition temperature Tg were each 16,000 and 98° C., respectively.

### Comparative Example 4

Comparative colored particles 8 were prepared in the same manner as in Example 1 except that 164.8 parts by weight of the following core particles I was used in place of 155 parts by weight of the dispersion C of core particles C.

The peak molecular weight measured by GPC and the glass transition temperature Tg of the colored particles 8 were each 30,000 and 98° C., respectively.

### Preparation Example 3 of Core Particles

The polymer particle dispersion B was prepared in the same manner as in the synthesis example 1 of core particles. In the third step of the polymerization, 142.2 parts by weight of styrene was replaced by 59.2 parts by weight of styrene and 60 parts by weight of methacrylic acid (MAA). Thus dispersion I of core particles I was obtained. The solid content of the dispersion I was 30.2% by weight. According to electron microscopic observation, the core particles 1 were like true sphere monodispersed particles having a volume based median diameter of 4.55 μm and a variation coefficient (CV value) of 7.4%. The peak molecular weight measured by GPC and the glass transition temperature Tg of the colored particles 8 were each 30,000 and 98° C., respectively.

### <Evaluation>

The optical density and the compression strength of the samples were measured for evaluating the coloring ability and the strength of the colored particles 1 to 5 and the comparative colored particles 6 to 8 each relating to Examples 1 to 5 and Comparative Examples 1, 2 and 4, respectively. The results of evaluation are shown in Table 1.

### (1) Coloring Ability

The colored particles were coated on a glass plate having a thickness of 0.7 mm so that the thickness of the coated layer was 10 μm in terms of square array and the glass plate was placed on a standard white plate having a refractivity of 90% so as to face the colored particles coated surface of the plate to the standard white plate. The reflective density was measured from the upper side (the side on which the colored particles were not coated) of the glass plate by a reflective densitometer TD918, manufactured by Macbeth.

### (2) Particle Strength

The micro compressing strength of randomly selected 10 colored particles having a diameter within the range of ±20% of the number average particle diameter was measured by a micro compression tester, manufactured by Shimadzu Corp., using a flat face compressing element of 50 μm at the maximum testing load of 198.8 mN and a loading rate of 2.65 mN/second under measuring condition of 21° C. and relative humidity of 50%. Among the ten measured results, the largest two and the smallest two values were omitted and the arithmetic average of the remaining 6 measured values was determined as the compressing strength in MPa.

TABLE 1

| | Particle | CV | | Particle |
|---|---|---|---|---|
| | diameter | value | Coloring | strength |
| | (μm) | (%) | ability | (MPa) |
| Example 1 | 5.20 | 7.4 | 1.84 | 47.2 |
| Example 2 | 4.92 | 10.1 | 0.32 | 45.6 |
| Example 3 | 5.62 | 13.2 | 1.78 | 44.2 |
| Example 4 | 5.10 | 8.1 | 1.86 | 47.8 |
| Example 5 | 5.04 | 6.1 | 1.79 | 46.2 |
| Comparative | 4.92 | 10.1 | 1.31 | 36.2 |
| example 1 | | | | |
| Comparative | 4.94 | 11.2 | 1.75 | 26.2 |
| example 2 | | | | |

| | |
|---|---|
| Comparative | Colored particles were not formed |
| example 3 | |

| | | | | |
|---|---|---|---|---|
| Comparative | 3.16 | 21.7 | 0.98 | 30.2 |
| example 4 | | | | |

As is above listed, it is confirmed that the high coloring ability and excellent strength can be obtained by the colored particles 1 to 5 relating to Examples 1 to 5.

1. Colored particles each of which composed of a core shell structure comprising a core particle and a colored shell layer formed on a surface of the core particle, wherein
the core particle is composed of a hydrophobic resin,
the colored shell layer comprises an active agent structure resin having a hydrophobic part and a hydrophilic part, and a colorant particle,
a volume based median particle diameter of the colored particles is 2 to 100 μm, and
a volume based CV value of the colored particles is 1.0 to 15.0%.

2. The colored particles of claim 1, wherein the volume based CV value of the colored particles is 1.0 to 10.0%.

3. A method of manufacturing the colored particles of claim 1, comprising a step of coagulating core particles, particles of the active agent structure resin having a hydrophobic part and a hydrophilic part, and the colorant particles in an aqueous medium to form the colored shell layer.

4. The method of claim 3, wherein a condition of 0.005<R2/R1<0.250 is satisfied, wherein
R1 is a volume based median particle diameter of the core particles, and
R2 is a volume based median particle diameter of the particles of the active agent structure resin having a hydrophobic part and a hydrophilic part.

5. The method of claim 4, wherein a condition of 0.010<R2/R1<0.200 is satisfied.

6. The method of claim 3, wherein the particles of the active agent structure resin having a hydrophobic part and a hydrophilic part is formed by polymerizing a monomer having a polymerizable hydrophobic group and a hydrophilic group.

7. The method of claim 5, wherein the monomer having a polymerizable hydrophobic group and a hydrophilic group is a vinyl monomer.

8. The method of claim 5, wherein the hydrophilic group is —SO₃⁻M⁺, —COO⁻M⁺, —PO₄⁻M⁺, —SO₃⁻M⁺, —N⁺(CH₃)₂.CH₂COO⁻, —COOH, —N⁺(CH₃)₃X⁻ or —O(CH₂CH₂O)ₘH, wherein M is a metal atom or ammonium group, X is a halogen atom, and m is an integer of 1 or more.
